(19) United States
(12) Patent Application Publication
(10) Pub. No.: US 2018/0371386 A1
(43) Pub. Date: Dec. 27, 2018

(54) HIGH PRESSURE PROCESSING (HPP) FOR INFUSING FLAVOR INTO LIQUIDS CONTAINING ALCOHOL

(71) Applicant: Tuco Spirits LLC, Nashotah, WI (US)

(72) Inventors: Gina Resch, Nashotah, WI (US); Sam J. Maglio, Mequon, WI (US)

(73) Assignee: Tuco Spirits LLC, Nashotah, WI (US)

(21) Appl. No.: 15/975,989

(22) Filed: May 10, 2018

Related U.S. Application Data
(60) Provisional application No. 62/523,503, filed on Jun. 22, 2017.

(51) Int. Cl. C12G 3/06

(52) U.S. Cl. CPC C12G 3/06

(57) ABSTRACT

A method for infusing a flavor from a substance into an infusion liquid. The method includes placing the infusion liquid and the substance into a vessel, where the infusion liquid contains alcohol. The method further includes providing a pressurization liquid in contact with the vessel, where the pressurization liquid has a pressure, where the vessel has a pressure, and where increasing the pressure of the pressurization liquid increases the pressure of the vessel. The method further includes pressurizing the pressurization liquid to a predetermined pressure for a predetermined duration. The flavor from the substance is infused into the infusion liquid by pressurizing the pressurization liquid at the predetermined pressure for the predetermined duration.

### CROSS REFERENCE TO RELATED APPLICATION

This application claims the benefit of U.S. Provisional Patent Application No. 62/523,503 filed Jun. 22, 2017, which is incorporated herein by reference in its entirety.

### FIELD

The present disclosure generally relates to infusing flavors into liquids, and more particularly to infusing flavors into liquids containing alcohol using high pressure processing (HPP).

### BACKGROUND

The Background and Summary are provided to introduce a foundation and selection of concepts that are further described below in the Detailed Description. The Background and Summary are not intended to identify key or essential features of the potentially claimed subject matter, nor are they intended to be used as an aid in limiting the scope of the potentially claimed subject matter.

### SUMMARY

One embodiment of the present disclosure generally relates to a method for infusing a flavor from a substance into an infusion liquid. The method includes placing the infusion liquid and the substance into a vessel, where the infusion liquid contains alcohol. The method further includes providing a pressurization liquid in contact with the vessel, where the pressurization liquid has a pressure, where the vessel has a pressure, and where increasing the pressure of the pressurization liquid increases the pressure of the vessel. The method further includes pressurizing the pressurization liquid to a predetermined pressure for a predetermined duration. The flavor from the substance is infused into the infusion liquid by pressurizing the pressurization liquid at the predetermined pressure for the predetermined duration.

Another embodiment of the present disclosure generally relates to a method for infusing a flavor from a substance into an infusion liquid. The method includes placing the infusion liquid and the substance into a vessel, where the infusion liquid contains at least 20% alcohol by volume, and where the vessel has a pressure therein. The method further includes sealing off the vessel such that the infusion liquid and the substance are retained inside the vessel. The method further includes placing the vessel into a chamber and providing a pressurization liquid within the chamber, where the chamber has a pressure therein, and where increasing the pressure inside the chamber increases the pressure inside the vessel. The method further includes controlling the pressure of the pressurization liquid with a controller module operating a program, where the program defines a plurality of predetermined pressures and predetermined durations for pressurizing the pressurization liquid based at least in part upon at least one of the infusion liquid and the substance inside the vessel. The method further includes pressurizing the pressurization liquid according to the controller module, wherein the pressurization is at least 7,250 PSI and for at least 30 seconds. The flavor from the substance is infused into the infusion liquid by pressurizing the pressurization liquid at the predetermined pressure for the predetermined duration.

Another embodiment of the present disclosure generally relates to a method for infusing a flavor from a substance into an infusion liquid. The method includes placing the infusion liquid and the substance into a vessel, where the infusion liquid contains at least 20% alcohol by volume, and where the vessel has a pressure therein. The method further includes sealing off the vessel such that the infusion liquid and the substance are retained inside the vessel. The method further includes controlling the pressure inside the vessel with a controller module operating a program, wherein the program defines a plurality of predetermined pressures and predetermined durations for pressurizing the vessel based at least in part upon at least one of the infusion liquid and the substance inside the vessel. The method further includes pressurizing the vessel according to the controller module, where the pressurization is at least 7,250 PSI and for at least 30 seconds. The flavor from the substance is infused into the infusion liquid by pressurizing the vessel at the predetermined pressure for the predetermined duration.

### BRIEF DESCRIPTION OF THE DRAWINGS

The drawings illustrate the best mode presently contemplated of carrying out the disclosure. The same numbers are used throughout the drawings to reference like features and like components. In the drawings:

FIG. 1 is a high level depiction of infusing a liquid with a substance to produce an infused beverage in the manner known in the art;

FIG. 2 is a schematic depiction of one embodiment of a system and method for producing an infused beverage using HPP according to the present disclosure;

FIG. 3 is a schematic depiction of another embodiment of a system and method for producing an infused beverage using HPP according to the present disclosure,

FIGS. 4A-6A depict exemplary recipes and experimental data using a system similar to that shown in FIG. 2; and

FIG. 6B depicts part of an exemplary system as used for collecting the experimental data in FIG. 6A.

### DETAILED DISCLOSURE

This written description uses examples to disclose embodiments of the present application, including the best mode, and also to enable any person skilled in the art to practice or make and use the same. The patentable scope of the invention is defined by the potential claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The present disclosure generally relates to methods and systems for improving the infusion of flavors from one or more substances into a liquid or into another substance, such as a food item. Specifically, the presently disclosed systems and methods incorporate using high pressure processing (HPP) to provide improved infused beverages. HPP is also referred to as high pressure pasteurization, Pascalization, bridgmanization, or high hydrostatic pressure (HHP) processing.

In general, infusion is the process by which one or more flavors or other chemical compounds dissolve into a solvent over time. This solvent may be a liquid, such as water, oil, or alcohol, or may be a food item in a substantially solid state, for example. Exemplary foods of interest for dissolving flavors include cheese, yogurt, and whole fruit. While the present disclosure principally refers to liquid solvents, applications involving solid and semi-solid solvents are also anticipated.

The basic concept of infusion is generally known and practiced as part of everyday life. This is particularly prevalent within the space of beverages. Among the most notable examples of infusion with beverages is the process of making of coffee, which can be performed through percolation, drip, or other techniques known in the art. The same occurs when steeping tea, or even placing a slice of lemon in a glass of water.

However, the present inventors have identified that the ability of a flavor from a first substance to dissolve in a liquid, particularly at room temperature and at atmospheric pressure, is often limited. The result is a longer amount of time necessary for the infusion, and/or a significant reduction in the amount of the first substance that dissolves in the liquid (i.e., less flavor, scent, and/or color). Moreover, when the particular liquid being dissolved in happens to contain alcohol, the ability to dissolve and thereby infuse flavor is even further diminished. As such, it is very challenging to create miscible results in liquids, and particularly those containing alcohol.

In certain circumstances, adding heat can assist in the process of infusion. This is why, for example, coffee is typically made using hot water, whereas “cold brewed” counterparts require substantially more time to achieve reasonable infusion levels. However, the present inventors have identified that it is often undesirable to incorporate heat, which can destroy or degrade the flavors of the substances to be infused, the flavors of the base infusion liquid (i.e., solvent), or other desirable chemical characteristics of either component and/or the mixture. Returning to the previous example, this is why some people prefer cold brewed coffee, which offers a distinct flavor, different levels of acidity, and other notable qualities. However, simply infusing over a longer duration also has consequences. In many cases, the additional time required for avoiding heat precludes efficient processing (or sufficient infusion levels), particularly in mass production. A hot brewed pot of coffee may require five to ten minutes to make, whereas a cold brewed equivalent can take several hours or more.

Through experimentation and development, the present inventors have identified that acceptable levels of infusion can be achieved—without adding heat—using the HPP systems and methods disclosed herein. In a first embodiment of the present disclosure, systems and methods incorporate HPP to infuse flavors into liquids containing alcohol. Specifically, the present inventors have identified that high pressure provided through HPP enhanced the extraction of water-based and oil-based flavor compounds from a substance for infusion into the liquid, which was particularly advantageous for the otherwise- difficult liquids containing alcohol.

For example, the present inventors identified that for liquids containing 35-55% alcohol (70-110 proof), conventional methods and systems for infusion known in the art provide limited capacity for either water-based or oil-based flavors to dissolve. In general, the water-based compounds dissolve into the water and the oil-based compounds dissolve into the alcohol. Therefore, it is particularly challenging to infuse flavor into a liquid containing alcohol since there is already a reduced portion of water even available. In other words, there is 50% less water capable of infusing water-based flavors for liquids that contain 50% alcohol). However, despite having a reduced capacity for infusion by traditional techniques, the consumer does not expect or desire a weaker or diluted tasting product. Instead, the consumer still expects to enjoy the same level of flavor customary of an non-alcoholic beverage. As such, the present inventors have identified that the systems and methods known in the art for infusing alcoholic beverages has created an unmet need by the consuming public.

It should be known that other proofs are also anticipated, including, for example 40 or 24 proof.

Through the systems and methods of the present disclosure, the extraction and infusion of all flavor components is maximized, addressing the public demand. This even includes infusion of the water-based flavors into the water portion of the liquid, which is challenging as previously stated. Furthermore, no addition of heat is required by the present disclosure. In this manner, any highly-sensitive antioxidant, aromatic, and/or other nutrient compounds that would normally be damaged by heat or other extraction processes are not negatively affected.

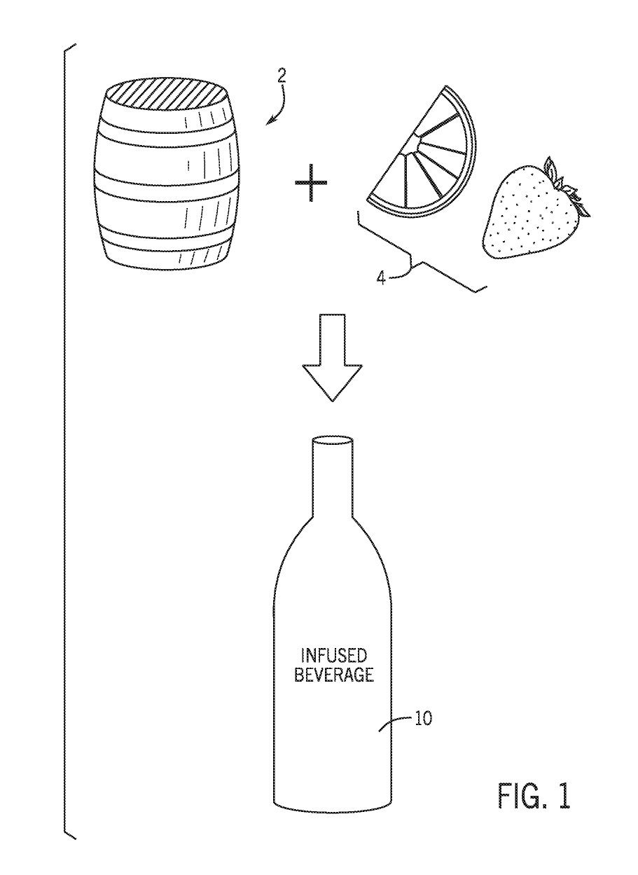

FIG. 1 depicts the general process of infusing a liquid (the infusion liquid 2) to provide a final infused beverage 10. Specifically, an exemplary infusion is depicted incorporating fruit as the substance 4, such as strawberry and lemon, into an infusion liquid 2 to provide a completed infused beverage 10. As previously described, infusion can occur by simply placing such substances 4 as fruit into a barrel of infusion liquid 2 to act as the solvent. The flavors and other chemicals are then allowed to be infused from the substances 4 into the infusion liquid 2, often at room temperature and atmospheric pressure, over time. However, as previously described, the level of infusion from such a configuration, particularly with infusion liquids 2 containing alcohol, is typically quite poor. This process would not provide satisfactory results for commercial applications in terms of infusion level, miscibility, and overall quality.

Moreover, this generally known infusion process leads to issues with excessive particulates in the final product. This results in undesirable changes to texture, color, and clarity in the infused beverage. In an effort to maximize infusion and minimize processing time, manufacturers often chop the flavor-containing substances for infusion into smaller pieces, which maximizes the surface area for diffusion. However, this process by definition creates more particulates, further exacerbating these secondary problems with the final product. Therefore, in addition to including this chopping process at the forefront, it creates the need for additional post-infusion processing to strain out the particulates. As will be recognized, this additional step only further increases processing time and corresponding expenses and complexities of production. Furthermore, straining may not remove all particulate matter, and may not be sufficient to resolve the issues with clarity of the final product. The smaller the original flavor-containing substances 4 were chopped, the more challenging this endeavor, and often the more inferior the final product. For these reasons and more, the infusion techniques presently known in the art often result in beverages having inferior clarity, texture, and taste.

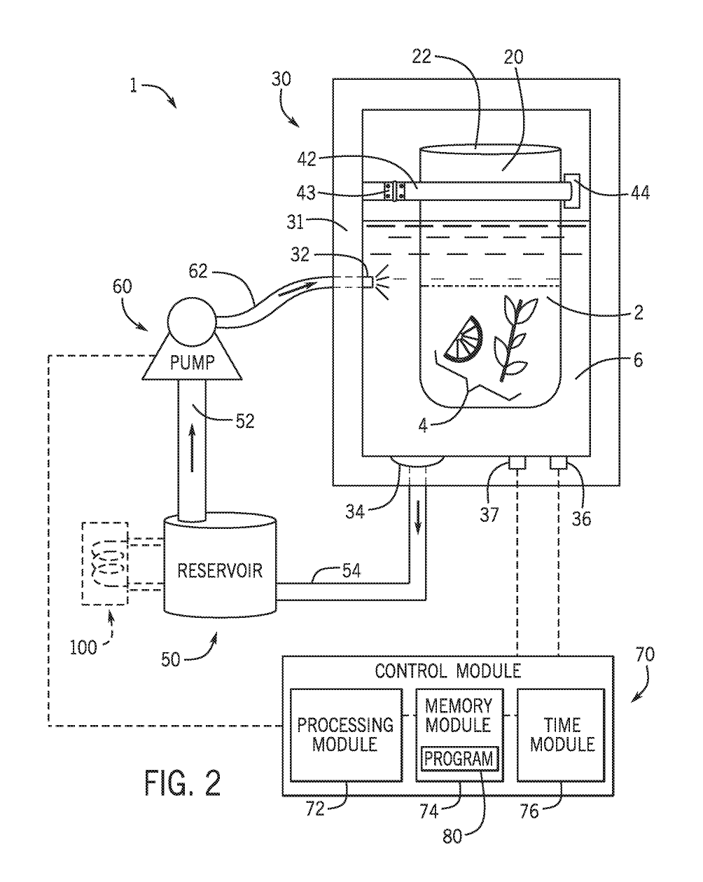

The present inventors have developed the following systems and methods incorporating HPP principles for infusing flavor into liquids, providing the desirable infusion and a high quality final product. An exemplary configuration in accordance with the present disclosure is shown in FIG. 2. FIG. 2 depicts a vessel 20 that is at least partially filled with an infusion liquid 2, which in the present case is a liquid containing alcohol, such as a spirit. Flavor substances 4, exemplified here as a slice of lemon and a sprig of mint, are added to the infusion liquid 2 within the vessel 20. It should be recognized that while the present embodiment shows the vessel 20 as a bag-like material, other types of vessels 20 are also anticipated, such as plastic bottles. It should be further recognized that flavor substances 4 other than fruits and herbs may be used, including juices or oils derived from plants, fungi, animals, and/or other substances.

In the system 1 shown in FIG. 2, the vessel 20 is a bag-like container fixed in place by a vessel holding device 40 within an HPP chamber 30. The vessel holding device 40 is configured to seal the vessel 20 (i.e., to make the vessel 20 air-tight) and retain the vessel 20 within the HPP chamber 30. In the present embodiment, the vessel holding device 40 is a locking spring clip having an arm 42 on a hinge 43, which locks via contact with a lock 44. However, it should be recognized that other mechanisms for substantially sealing the vessel 20 and/or retaining the vessel 20 within the HPP chamber 30 would be known to one of ordinary skill in the art. These include, for example, a screw top for sealing the vessel 20 and a receiving bracket within the chamber 30, which also demonstrates that these functions may be divided across multiple devices. In other embodiments, the vessel 20 may not be fixed within the HPP chamber 30 at all, or may be shaped or sized to directly engage with inner walls or other features of the HPP chamber 30 to be retained therein.

Once the vessel 20 is placed within the HPP chamber 30, the HPP chamber 30 in certain embodiments is filled with a pressurization liquid 6. Specifically, a volume of the pressurization liquid 6 is pumped from a reservoir 50 into the HPP chamber 30 via a port 32. This process may be facilitated by a pump 60, be gravity-fed, or may use other techniques for transporting liquids known in the art. In certain embodiments, the pump 60 and various valves within the HPP chamber 30, including a drain valve 34, are controlled by a control module 70. However, one or more of these elements may be actuated manually. In the embodiment of FIG. 2, the pump 60 communicates with the chamber 30 via a conduit 62 and with the reservoir 50 via a conduit 62. Another conduit 54 communicates between the reservoir 50 and chamber 30.

Certain embodiments further incorporate the use of pressure sensor 36, temperature sensor 37, and/or other gauges to monitor the environmental conditions within the HPP chamber 30, the vessel 20, the reservoir 50, and/or pressurization liquid 6, for example. This further ensures consistency and quality, both within and between batches of infused beverages.

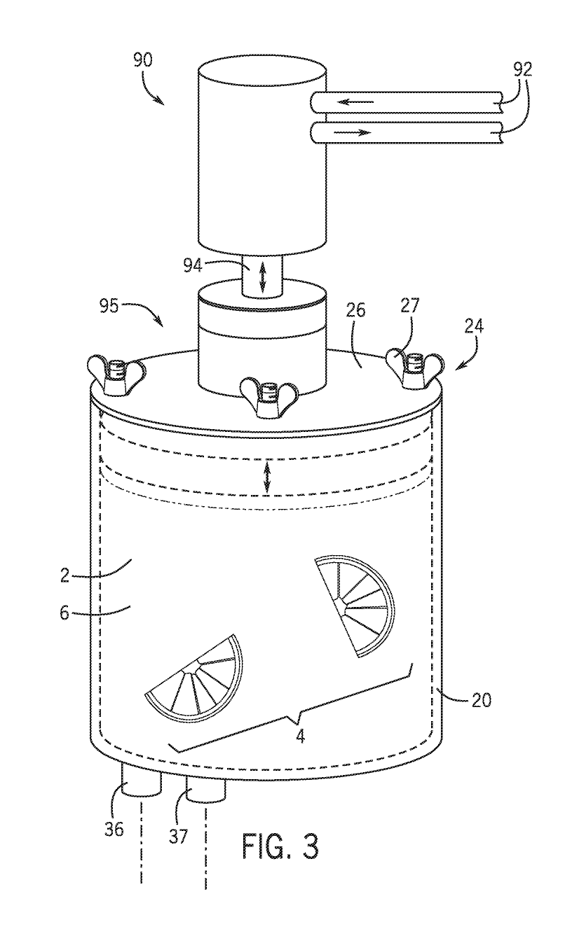

In one embodiment, the control module 70 includes a processing module 72 that operates the pump 60 and various drains (such as drain 34) in accordance with a program 80 that is stored within a memory module 74. The control module 70 further communicates with the pressure sensor 36 operably coupled within the HPP chamber 30 that senses the pressure created therein by the pumping of pressurization liquid 6 into the HPP chamber 30. Data from the pressure sensor 36, along with information from a time module 76 also contained within the control module 70, are incorporated into models and protocols (also referred to as recipes 82) within the program 80 in the memory module 74. Together, this data, along with the program 80, define how the processing module operates the pump 60 to control the HPP process. The program 80 in certain embodiments defines separate parameters based on the particular infusion liquid 2, substances 4 to be infused, and relative volumes and/or weights thereof. Exemplary recipes 82 and exemplary data collected by the present inventors can be seen in FIGS. 3A and 3B.

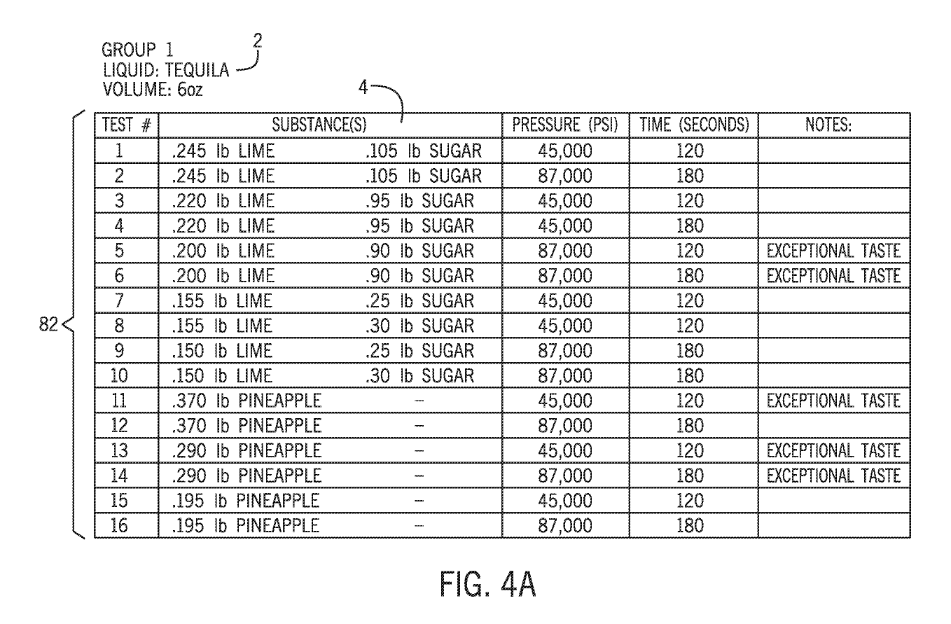

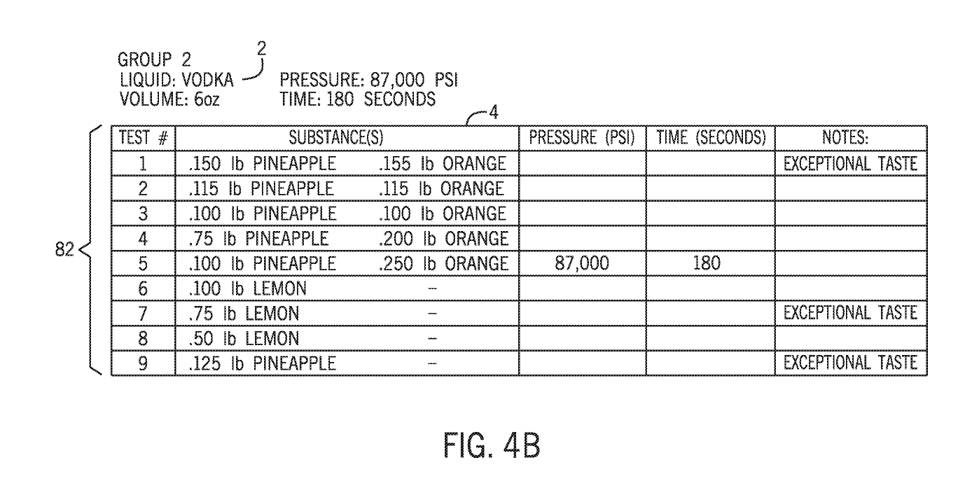

In one example, the control module 70 controls the HPP chamber 30, including the pump 60 and thus the pressure within the HPP chamber 30, to provide a pressure within the HPP chamber of 45,000 PSI for a time of 120 seconds. FIGS. 4A and 4B provide exemplary experimental data taken for two groups of liquids following these and other recipes 82. In the examples shown, the infusion liquids 2 were infused with flavors from various substances and were subjected to varying pressures and for varying times. Successful infusion and commercially acceptable miscibility was accomplished across the full range of values, as shown, with particularly exceptional flavors also being identified. However, it should be recognized that the experimental data of FIGS. 4A and 4B are not limiting on the scope of the presently disclosed methods and systems and merely demonstrates exemplary pressures, times, substances 4, and infusion liquids 2. Through experimentation and development, the present inventors have identified that pressures ranging at least from 50 Mpa to 800 Mpa (7,250 PSI to 116,000 PSI) and over a dwell time ranging from at least 30 seconds to 30 minutes to yield particularly favorable products when using the presently disclosed systems and methods. However, values beyond these ranges are also anticipated.

Returning to the exemplary system of FIG. 2, after the control module 70 has operated the HPP chamber 30 in accordance with the pressure and time parameters of a particular program 80, the pump 60 is stopped and a drain 34 in the HPP chamber 30 is opened. This allows the pressurization liquid 6 to exit through the drain 34 and back into the reservoir 50 for the next cycle of use. In certain embodiments, only a portion of the pressurization liquid 6 is retained within the HPP chamber 30 and not returned to the reservoir 50. Likewise, the present disclosure anticipates other methods and systems for pressurizing the HPP chamber 30, including pneumatic, hydraulic, and/or pneumatic-hydraulic hybrid configurations.

One such exemplary embodiment is shown in FIG. 3, wherein the vessel 20 itself is the HPP chamber 30 and is pressurized using a plunger 96 on a rod 94 driven by a hydraulic cylinder 90 to pressurize the infusion liquid 2 directly. In other words, the infusion liquid 2 itself is also the pressurization liquid 6. In this example, the hydraulic cylinder 90 is fed by hydraulic lines 92 and operated in a customary manner. A sealed coupler 95 seals between the rod 94 and the vessel 20.

While the embodiments previously shown generally depict systems 1 for processing a single vessel 20 in a batch production system 1, the present disclosure further anticipates systems 1 that permit multiple vessels 20 to undergo HPP processing simultaneously, or systems 1 providing a continuous process between multiple HPP chambers 30. In another exemplary embodiment, one HPP chamber 30 is filled with pressurization liquid 6 that is being drained from another HPP chamber 30 that was processed before it.

While not expressly depicted, other elements may be further incorporated into the system to enhance performance. For example, a cooling system 100 may be incorporated such that operation of the pump 60 does not cause an undesired increase in the temperature of the pressurization liquid 6 and, consequently, the HPP chamber 30. Such heating, and particularly over-heating, may cause deleterious effects in the infusion process or to the chemical characteristics of the infusion liquid 2, flavor substances 4, or the integrity of the vessel 20 and other components of the system 1.

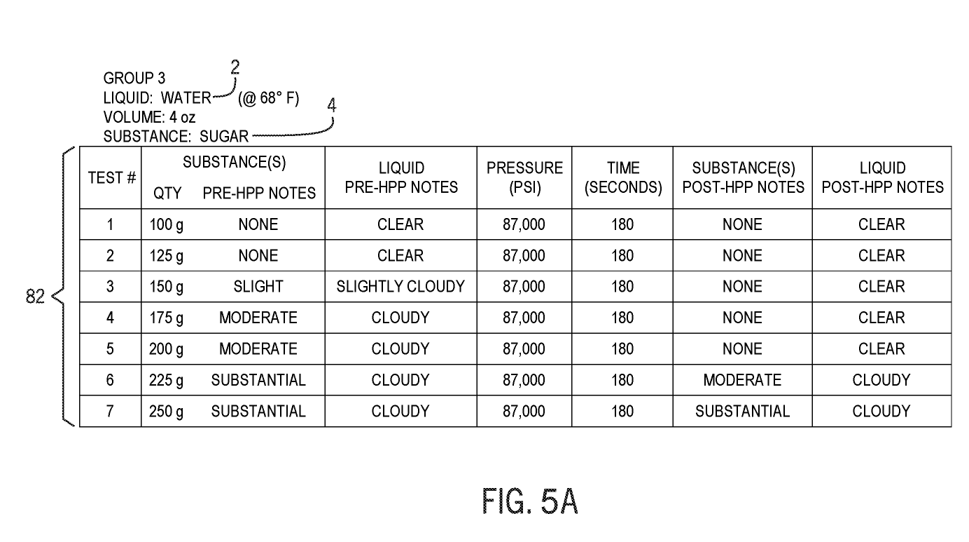

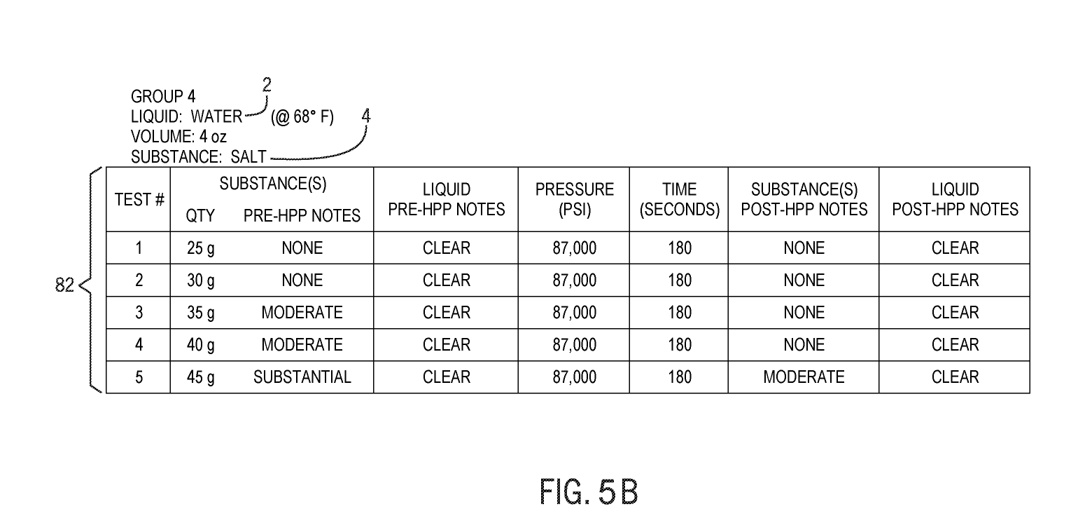

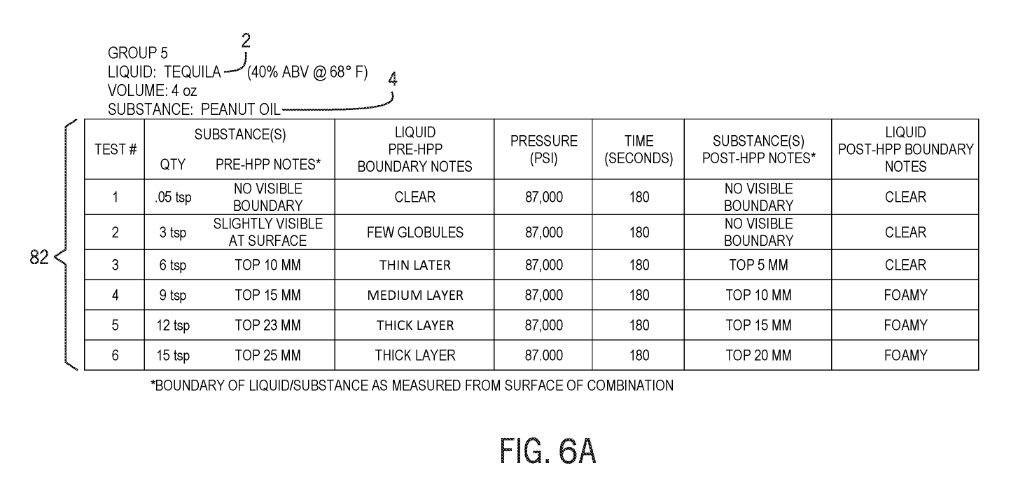

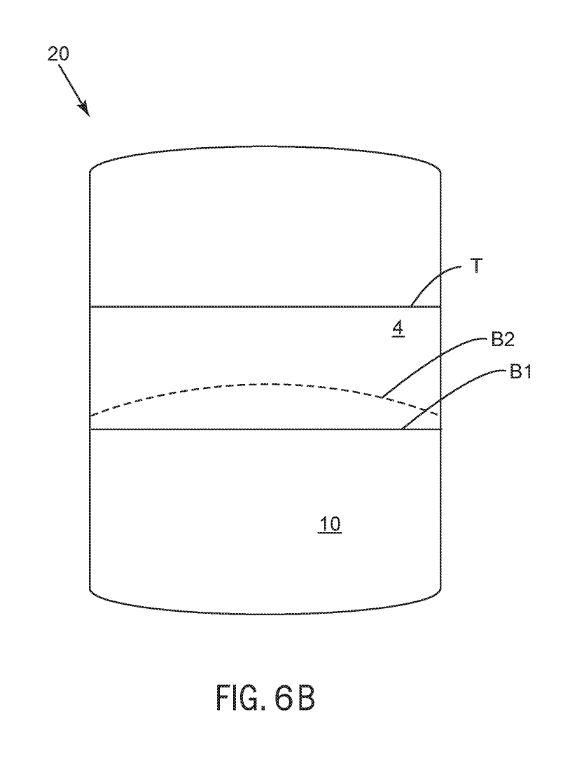

Additional exemplary experimental results are provided in FIGS. 5A through 6A, which particularly exemplify how the presently disclosed methods and systems improve the ability of an infusion liquid 2 to dissolve substances 4. In particular, FIGS. 5A and 5B depict recipes 82 in which sugar and salt are the substances 4, respectively, dissolved in water as the infusion liquid 2. As the data shows, the application of HPP in accordance with the present disclosure resulted in a reduction of detectable or perceiveable substances 4 when combined with the infusion liquid 2 (relative to pre-HPP levels), as well improved clarity thereof. For example, 200g of sugar within 4 oz of water as the infusion liquid 2 had “moderate” perceiveability upfront, along with a “cloudy” appearance of the infusion liquid 2. However, after introducing 87,000 PSI for 180 seconds, the substance 4 was no longer perceiveable and the infusion liquid 2 was clear (see FIG. 5A, Test #5). This demonstrates that the methods and systems employed in accordance with the present disclosure resulted in improved dissolving of the substance 4 and an overall improved final product (i.e., including the clarity of the infusion liquid 2).

Exemplary experimental data relating to the improved ability of even alcohol as the infusion liquid 2 to dissolve substances 4 is provided in FIG. 6A. In this example, 40% alcohol by volume tequila was used as the infusion liquid 2, with peanut oil as the substance 4. As shown in the exemplary measurements of FIG. 6B, the total T of the combined infusion liquid 2 and substances 4 was marked before applying the HPP processes presently disclosed. Likewise, a first boundary line B1 was marked at the boundary between the infusion liquid 2 and the substance 4 since, after allowing for settling resulted, the oil floated on top of the tequila. In the exemplary data shown, 87,000 PSI was then applied to the vessel 20 for 180 seconds. A second boundary line B2 was then marked at the boundary between the infusion liquid 2 and the substance 4 after this HPP process was concluded. This allowed the present inventors to visually determine how much of the substance 4 had dissolved into the infusion liquid 2 by virtue of the HPP process (i.e., the remaining, non-dissolved oil still being available to float on the surface).

As shown in the data of FIG. 6A, when 9 tsp of peanut oil as the substance 4 was added to 4 oz of tequila as the infusion liquid 2, the top 10 mm of the combination was initially measured to be the substance 4 (see Test #4). The appearance of the infusion liquid 2 at the boundary was simply a thin layer of oil floating on top. Following the HPP process, the non-dissolved substance 4 amounted to the top 5 mm of the combination being the substance 4, a reduction of 5 mm. The infusion liquid 2 remained clear at the boundary.

The present inventors further identified that with recipes 82 having a greater relative quantity of substance 4 (i.e., Test #6), the measured distance between the total T of the combined infusion liquid 2 and substances 4 and the first boundary line B1 decreased relative to the measured distance to the second boundary line B2. However, the infusion liquid 2 at the boundary (i.e., at second boundary line B2) appeared foamy. Moreover, the second boundary line B2 was not a substantially flat line as with the first boundary line B1, but arched upwardly towards the center of the vessel 20.

In this manner, the experimental data reflected in FIGS. 4A-6A demonstrate the ability of the presently disclosed methods and systems to improve infusion of flavors (i.e., from substances 4) into infusions liquids 2 over conventional techniques known in the art.

The presently disclosed methods and systems have additional advantages for processing wines and spirits. In particular, it is readily recognized that aging wines and spirits often improves antioxidant, aromatic, and other taste and quality characteristics that are appreciated by consumers. In fact, the value of such a wine or spirit is often based in large part on the length and conditions of its aging process. However, the present inventors have further identified through experimentation and development that the same or similar characteristics of aging can also be obtained through the use of HPP. Using HPP rather than aging a wine or spirit over time substantially improves cost by not requiring the holding of inventory, by avoiding spoilage, and by producing end-products more responsively to actual consumer demand rather than forward projections. In addition, the presently disclosed systems and methods minimize the losses of the “Devil's Cut”, or the alcohol that is lost through evaporation during the aging process.

Similarly, the present inventors have identified that the methods and systems have particular advantages for the production of spirits such as whiskey. In whiskey production, the characteristics associated with aging are primary drivers of the final taste and quality, as well as the consequent value of the particular spirit. In traditional methods, the pre-aged whiskey is placed in charred wooden barrels and aged for months to many years. Through the methods and systems disclosed herein, similar benefits can be obtained by placing charred wood and whiskey within the same vessel 20 under HPP. In one exemplary recipe 82, the charred wood is the substance 4 within the whiskey as the infusion liquid 2 is pressurized to 87,000 PSI for 180 seconds.

It should be recognized that the benefits of infusion and aging are not mutually exclusive, whereby both benefits may be attained for a single infused beverage 10 through the presently disclosed methods and systems.

In the above description, certain terms have been used for brevity, clarity, and understanding. No unnecessary limitations are to be inferred therefrom beyond the requirement of the prior art because such terms are used for descriptive purposes and are intended to be broadly construed. The different assemblies described herein may be used alone or in combination with other devices. It is to be expected that various equivalents, alternatives and modifications are possible within the scope of any appended claims.

We claim:

1. A method for infusing a flavor from a substance into an infusion liquid, the method comprising:
placing the infusion liquid and the substance into a vessel, wherein the infusion liquid contains alcohol;
providing a pressurization liquid in contact with the vessel, wherein the pressurization liquid has a pressure, wherein the vessel has a pressure, and wherein increasing the pressure of the pressurization liquid increases the pressure of the vessel; and
pressurizing the pressurization liquid to a predetermined pressure for a predetermined duration;
wherein the flavor from the substance is infused into the infusion liquid by pressurizing the pressurization liquid at the predetermined pressure for the predetermined duration.

2. The method according to claim 1, wherein the pressurization liquid and the infusion liquid have different chemical properties.

3. The method according to claim 1, further comprising positioning the vessel within a chamber, wherein the pressurization liquid is provided inside the chamber and outside the vessel, and wherein the pressurization liquid is provided in contact with the vessel.

4. The method according to claim 3, wherein the chamber includes a port that communicates the pressurization liquid between the chamber and a reservoir, further comprising retaining at least a portion of the pressurization liquid within the reservoir when the pressurization liquid is not pressurized, and wherein the pressurization liquid is pressurized by communicating the pressurization liquid from the reservoir to the chamber.

5. The method according to claim 4, further comprising pumping the pressurization liquid from the reservoir to the chamber with a pump to pressurize the pressurization liquid.

6. The method according to claim 5, further comprising controlling the pump with a controller module, storing a program within the controller module, and defining the predetermined pressure and the predetermined duration for pressurizing the pressurization liquid within the program.

7. The method according to claim 6, wherein the predetermined pressure comprises multiple predetermined pressures and the predetermined duration comprises multiple predetermined durations, further defining the multiple predetermined pressures and the multiple predetermined durations based on at least one of the infusion liquid and the substance placed in the vessel.

8. The method according to claim 3, further comprising actuating a plunger that acts upon the pressurization liquid to pressurize the pressurization liquid.

9. The method according to claim 1, wherein the pressurization liquid and the infusion liquid are one liquid.

10. The method according to claim 9, wherein the vessel includes a port that communicates the pressurization liquid between the vessel and a reservoir, further comprising retaining at least a portion of the pressurization liquid within the reservoir when the pressurization liquid is not pressurized, and wherein the pressurization liquid is pressurized by communicating the pressurization liquid from the reservoir to the vessel.

11. The method according to claim 10, further comprising pumping the pressurization liquid from the reservoir to the chamber with a pump to pressurize the pressurization liquid.

12. The method according to claim 11, further comprising controlling the pump with a controller module, storing a program within the controller module, and defining the predetermined pressure and the predetermined duration for pressurizing the pressurization liquid within the program.

13. The method according to claim 13, wherein the predetermined pressure comprises multiple predetermined pressures and the predetermined duration comprises multiple predetermined durations, further defining the multiple predetermined pressures and the multiple predetermined durations based on at least one of the infusion liquid and the substance placed in the vessel.

14. The method according to claim 9, further comprising actuating a plunger that acts upon the pressurization liquid to pressurize the pressurization liquid.

15. The method according to claim 1, wherein the infusion liquid is at least 20% alcohol by volume.

16. The method according to claim 15, wherein the infusion liquid is tequila and wherein the substance includes at least fruit.

17. The method according to claim 1, wherein the predetermined pressure is at least 7,250 PSI and the predetermined duration is between 30 seconds and 30 minutes.

18. The method according to claim 1, wherein the pressurization liquid is a sterile water solution.

19. A method for infusing a flavor from a substance into an infusion liquid, the method comprising:
placing the infusion liquid and the substance into a vessel, wherein the infusion liquid contains at least 20% alcohol by volume, and wherein the vessel has a pressure therein;
sealing off the vessel such that the infusion liquid and the substance are retained therein;
placing the vessel into a chamber;
providing a pressurization liquid within the chamber, wherein the chamber has a pressure therein, and wherein increasing the pressure inside the chamber increases the pressure inside the vessel; and
controlling the pressure of the pressurization liquid with a controller module operating a program, wherein the program defines a plurality of predetermined pressures and predetermined durations for pressurizing the pressurization liquid based at least in part upon at least one of the infusion liquid and the substance inside the vessel;
pressurizing the pressurization liquid according to the controller module, wherein the pressurization is at least 7,250 PSI and for at least 30 seconds;
wherein the flavor from the substance is infused into the infusion liquid by pressurizing the pressurization liquid at the predetermined pressure for the predetermined duration.

20. A method for infusing a flavor from a substance into an infusion liquid, the method comprising:
placing the infusion liquid and the substance into a vessel, wherein the infusion liquid contains at least 20% alcohol by volume, and wherein the vessel has a pressure therein;
sealing off the vessel such that the infusion liquid and the substance are retained therein;
controlling the pressure inside the vessel with a controller module operating a program, wherein the program defines a plurality of predetermined pressures and predetermined durations for pressurizing the vessel based at least in part upon at least one of the infusion liquid and the substance inside the vessel;
pressurizing the vessel according to the controller module, wherein the pressurization is at least 7,250 PSI and for at least 30 seconds;
wherein the flavor from the substance is infused into the infusion liquid by pressurizing the vessel at the predetermined pressure for the predetermined duration.
